(19) United States
(12) Patent Application Publication
(10) Pub. No.: US 2009/0190700 A1
(43) Pub. Date: Jul. 30, 2009

(54) METHODS AND DEVICES FOR PROCESSING SIGNALS TRANSMITTED VIA COMMUNICATION SYSTEM

(76) Inventor: Jeng-Shiann Jiang, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/021,311

(22) Filed: Jan. 29, 2008

(51) Int. Cl. H04B 1/10

(52) U.S. Cl. 375/350

(57) ABSTRACT

A method for processing signals transmitted via a communication system includes: generating a first parameter associated with a signal power of a first signal; performing an adjacent channel interference (ACI) filtering operation upon the first signal to generate a second signal; generating a second parameter associated with a signal power of the second signal; comparing the first parameter with the second parameter to generate a comparison result; and detecting whether ACI exists in the communication system according to the comparison result to generate a detection result.

### BACKGROUND OF THE INVENTION

1. Field of the Invention

The present invention relates to processing signals transmitted via a communication system, and more particularly, to methods and devices for detection of adjacent channel interference (ACI) in an American Television Systems Committee (ATSC) system.

2. Description of the Prior Art

Due to sharing the same frequency band as conventional television broadcasting systems such as the National Television System Committee (NTSC) system, the American Television Systems Committee (ATSC) system often encounters the problem of adjacent channel interference (ACI). To counter the effect of the ACI signal, ACI filters are used in the receiver of the ATSC system; however, some unwelcome effect is also introduced at the same time. For example, if there is no ACI, the information carried by received signals may be filtered out due to ACI filtering and hence the performance of the receiver will deteriorate.

Please refer to FIG. 1. FIG. 1 illustrates the frequency domain graph of the signals in a prior art ATSC system. The curve 110 represents the desired ATSC signal, while the curve 112 is an ACI signal; additionally, the curve 114 represents a frequency response of an ACI filter. If the ACI filter is not implemented in the receiver, the desired signal 110 could be corrupted by the ACI signal 112. After passing the ACI filter, most ACI effect can therefore be eliminated or alleviated; however, due to the imperfect characteristics of the filter (e.g. the roll-off rate of the filter is not sharp enough), distortion of the desired ATSC signal is generated after the operation of the ACI filter, as shown by the resulting curve 116 in FIG. 1. Since the occurrence of the ACI is volatile in the ATSC system, always enabling the ACI filter even when ACI is absent or negligible may degrade the system performance. Therefore, a novel mechanism of detecting ACI occurrence should be devised to control the operation of the ACI filter according to the existence of ACI to thereby improve the system performance.

### SUMMARY OF THE INVENTION

It is therefore one of the objectives of the claimed invention to provide methods and devices for processing signals transmitted via a communication system to solve the aforementioned problems.

According to one embodiment of the claimed invention, a method for processing signals transmitted via a communication system is disclosed. The method comprises: generating a first parameter associated with a signal power of a first signal; performing an adjacent channel interference (ACI) filtering operation upon the first signal to generate a second signal; generating a second parameter associated with a signal power of the second signal; comparing the first parameter with the second parameter to generate a comparison result; and detecting whether ACI exists in the communication system according to the comparison result to generate a detection result.

As well as the method mentioned above, a device for processing signals transmitted via a communication system is further disclosed according to one embodiment of the claimed invention. The device comprises: a first power estimator for generating a first parameter associated with a signal power of a first signal; an adjacent channel interference (ACI) filter for performing an ACI filtering operation upon the first signal to generate a second signal; a second power estimator for generating a second parameter associated with a signal power of the second signal; a comparator for comparing the first parameter with the second parameter to generate a comparison result; and a decision unit for detecting whether ACI exists in the communication system according to the comparison result in order to generate a detection result.

According to yet another embodiment of the claimed invention, a device for processing signals transmitted via a communication system is provided. The device includes: a decision logic for detecting whether adjacent channel interference (ACI) exists in the communication system to generate a detection in a time domain; and a controller coupled to the decision unit by selectively enabling or disabling an ACI filtering operation for filtering out the ACI of a received signal according to the detection result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a frequency domain graph of signals in a prior art American Television Systems Committee (ATSC) system.

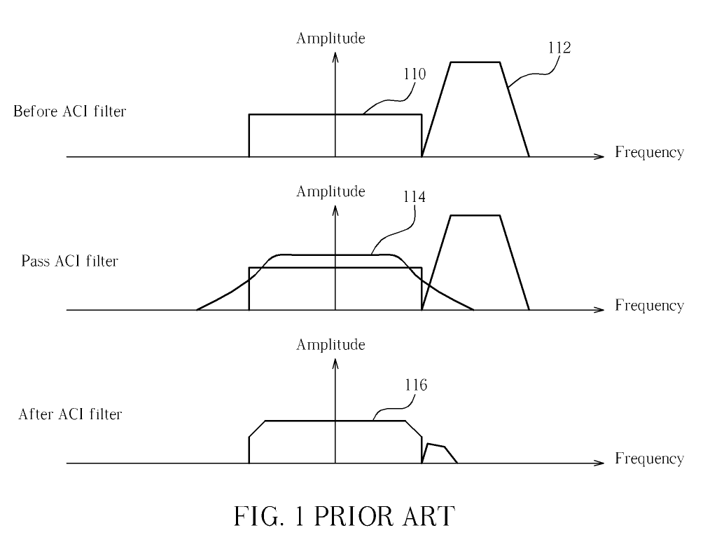

FIG. 2 illustrates a block diagram of a signal processing circuit for detecting adjacent channel interference (ACI) in the ATSC receiver according to a first embodiment of the invention.

FIG. 3 illustrates a block diagram of a signal processing circuit for detecting the ACI in an ATSC receiver according to a second embodiment of the invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

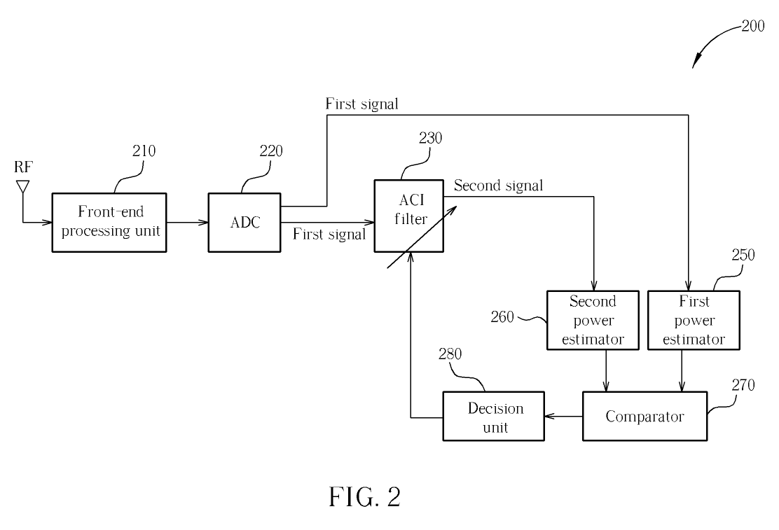

Please refer to FIG. 2. FIG. 2 illustrates the block diagram of a signal processing circuit 200 for detecting adjacent channel interference (ACI) in the American Television Systems Committee (ATSC) receiver according to a first embodiment of the invention. The signal processing circuit 200 comprises a first power estimator 250, a second power estimator 260, a comparator 270, and a decision unit 280. As shown in FIG. 2, the received ATSC signal will first be converted to a baseband signal by the front-end processing unit 210. The baseband signal is then sampled and digitized using an analog-to-digital converter (ADC) 220. After that, the digitized signal is inputted into an ACI filter 230, which is initially turned on. As the technique of an ATSC system is well known to those skilled in this art, related details are not repeated here for brevity.

To detect the ACI signal, the first power estimator 250 estimates a parameter associated with a signal power of a received signal before fed into the ACI filter 230, and the second power estimator 260 estimates a parameter associated with a signal power of a received signal after being filtered by the ACI filter 230 respectively.

Hence, for detecting the ACI occurrence, the first power estimator 250 is configured to generate a parameter Ps which is associated with the signal power of the received signal before an ACI filtering operation. In addition, the second power estimator 260 is configured to estimate a parameter Pv, which is associated with a signal power of a received signal after being filtered by the ACI filter 230. Further operations are detailed as below.

In this exemplary implementation, the signal power of a digitized signal is derived from an average value of the summation of the square of the magnitude (i.e., the absolute value of the signal) of the digitized signal. Therefore, the method of estimating the signal power is calculating an average of the summation of the square of absolute value of these two digitized signals as follows:

Pₛ=(Σ_{n=0˜(N-1)}|s(n)|²)/N (1)

Pᵥ=(Σ_{n=0˜(N-1)}|v(n)|²)/N (2)

In the above equations, s(n) is the input signal of the ACI filter 230, which represents the received signal before ACI filtering is applied; while v(n) is the output signal of the ACI filter 230, which illustrates the received signal after ACI filtering has been applied. Accordingly, Pₛ represents signal power of the received signal before ACI filtering, and Pᵥ represents signal power of the received signal after ACI filtering. Please note that n represents a sample index, and N represents length of the detection window over which the signal should be observed. Please note that the method of estimating the signal power is not limited to the above equations. Any equation that can derive the signal power (such as summation of the absolute value of the digitized signal) can be employed in this invention, and this also falls within the scope of this invention.

The comparator 270 then compares two values Ps and βPv, in which β is a predetermined threshold value. The decision unit 280 will determine whether ACI exists based on the following criterion:

If Pₛ>βPᵥ, ACI exists; otherwise, ACI is absent.

In this exemplary embodiment, the signal power of the received signal Pₛ is substantially equal to the signal power of the filtered signal Pᵥ if ACI is absent. If ACI exists, Pₛ should be greater than Pᵥ since Pₛ represents the summation of the signal power of the desired signal and the ACI signal. For example, the comparator 270 may use a divider (not shown) to determine the ratio between the signal power of received signal before ACI filtering and the signal power of received signal after ACI filtering, i.e., Ps/Pv; then uses a comparing circuit (not shown) to compare the ratio Ps/Pv with the above-mentioned threshold β to generate a comparison result. The same objective of detecting the ACI occurrence is achieved.

Please note that a divider and a comparing circuit are used in the comparator 270 for comparing the two values Ps and βPv, but it is not meant to be a limitation of the present invention. Other circuit designs that are capable of comparing the signal power before ACI filtering and the signal power after ACI filtering are still obey the spirit of the invention, and also fall within the scope of the present invention.

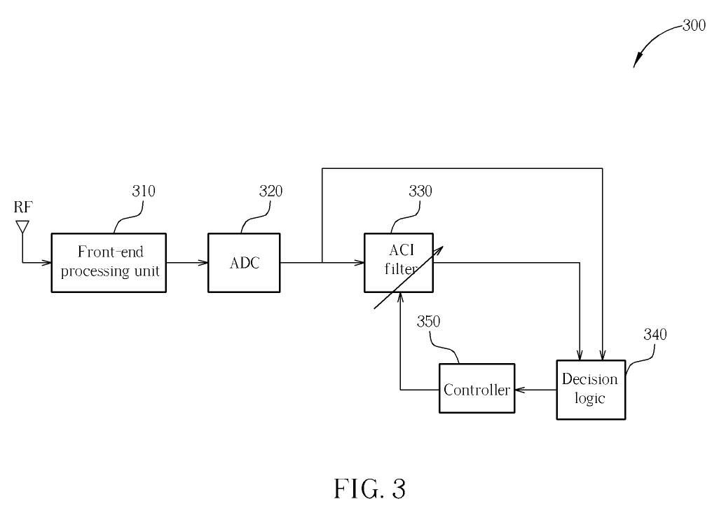

Please refer to FIG. 3. FIG. 3 illustrates a block diagram of a signal processing circuit for detecting the ACI in an ATSC receiver according to a second embodiment of the invention. The signal processing circuit 300 comprises a front-end processing unit 310, an ADC 320, an ACI filter 330, a decision logic 340, and a controller 350. The decision logic 340 is configured for detecting whether ACI exists in the communication system through a time domain analysis. Then, the controller 350 selectively enables or disables the controllable ACI filter 330 according to the detection result generated from the decision logic 340. In other words, an output signal is generated from the ACI filter 330 by selectively enabling or disabling an ACI filtering operation for filtering out the ACI of the received signal. The decision logic 340 in FIG. 3 can be implemented using the circuit components shown in FIG. 2. However, any circuit configuration capable of detecting the ACI in time domain and then selectively enabling or disabling the ACI filtering operation (i.e., the controllable ACI filter 330) according to the ACI detection result can be employed in the decision logic 340 and the controller 350. These alternative designs also obey the spirit of the present invention, and fall in the scope of the present invention. Since other operation of the signal processing circuit 300 in FIG. 3 is approximately the same with that of the signal processing circuit 200 in FIG. 2, the related detail is not repeated here for brevity.

It is well known that the ACI filter 230 is utilized for filtering the ACI. Since the ACI filter 230 is initially turned on, the ACI component would be filtered out if the received signal contains the ACI component. The signal power of the received signal before ACI filtering should be larger than the signal power of the received signal after ACI filtering because the ACI component is introduced in the receiver. However, if the received signal does not have ACI component, the signal power of the received signal before ACI filtering should be substantially the same with the signal power of the received signal after ACI filtering.

Therefore, the receiver can adaptively control the ACI filtering operation according to the existence of ACI. That is to say, the received signal will not be distorted by the ACI filtering when ACI is absent, while in the situation when ACI is present, the receiver can still generate correct output signal by filtering out the ACI. Hence, by using the ACI detection mechanism described above, this exemplary embodiment can provide an improved way to control the ACI filtering operation based on the existence of the ACI, and therefore can provide better signal performance.

As known to those skilled in the art, in communication system, the greater the absolute value of a signal component is, the stronger the signal power of the signal component at the specific frequency is. In addition, if the ATSC receiver of the present invention is immovable under normal operation, the above ACI detecting operation is performed once after the receiver is powered on or after the receiver selects a new channel. Otherwise, if the receiver is movable such as applied in a vehicle or other transportation devices, the above ACI detecting operation should keep executing.

Please note that the circuit configuration respectively shown in FIG. 2 and FIG. 3 are for illustrative purposes only, and are not meant to be limitations of the present invention. In addition, any method that can derive the approximate value of a signal power of the signal and/or calculate a ratio between the received signal before ACI filtering operation and the received signal after ACI filtering operation obeys the spirit of the invention and falls within the scope of the invention.

Those skilled in the art will readily observe that numerous modifications and alterations of the device and method may be made while retaining the teachings of the invention.

What is claimed is:

1. A method for processing signals transmitted via a communication system, comprising:
generating a first parameter associated with a signal power of a first signal;
performing an adjacent channel interference (ACI) filtering operation upon the first signal to generate a second signal;
generating a second parameter associated with a signal power of the second signal;
comparing the first parameter with the second parameter to generate a comparison result; and
detecting whether ACI exists in the communication system according to the comparison result to generate a detection result.

2. The method of claim 1, wherein the communication system is a digital television system.

3. The method of claim 2, wherein the communication system complies with an Advanced Television Systems Committee (ATSC) standard.

4. The method of claim 1, further comprising:
selectively enabling or disabling an ACI filtering operation for filtering out the ACI of the received signal according to the detection result.

5. The method of claim 1, wherein the step of detecting whether ACI exists in the communication system comprises:
when the comparison result indicates that a ratio of the first parameter to the second parameter is greater than a threshold value, determining that ACI exists; and
when the comparison result indicates that the ratio of the first parameter to the second parameter is not greater than the threshold value, determining that ACI is absent.

6. A device for processing signals transmitted via a communication system, comprising:
a first power estimator, for generating a first parameter associated with a signal power of a first signal;
an ACI filter, for performing an adjacent channel interference (ACI) filtering operation upon the first signal to generate a second signal;
a second power estimator, coupled to the ACI filter, for generating a second parameter associated with a signal power of the second signal;
a comparator, coupled to the first power estimator and the second power estimator, for comparing the first parameter with the second parameter to generate a comparison result; and
a decision unit, coupled to the comparator, for detecting whether adjacent channel interference (ACI) exists in the communication system according to the comparison result to generate a detection result.

7. The device of claim 6, wherein the communication system is a digital television system.

8. The device of claim 7, wherein the communication system complies with an Advanced Television Systems Committee (ATSC) standard.

9. The device of claim 6, wherein the decision unit further selectively enables or disables the ACI filter according to the detection result.

10. The device of claim 6, wherein the decision unit determines that ACI exists when the comparison result indicates that a ratio of the first parameter to the second parameter is greater than a threshold value; and the decision determines that ACI is absent when the comparison result indicates that the ratio of the first parameter to the second parameter is not greater than the threshold value.

11. A device for processing signals transmitted via a communication system, comprising:
a decision logic, for detecting whether adjacent channel interference (ACI) exists in the communication system to generate a detection result in a time domain; and
a controller, coupled to the decision unit, for selectively enabling or disabling an ACI filtering operation for filtering out the ACI of a received signal according to the detection result.

12. The device of claim 11, wherein the communication system is a digital television system.

13. The device of claim 12, wherein the communication system complies with an Advanced Television Systems Committee (ATSC) standard.
